(19) United States
(12) Patent Application Publication
(10) Pub. No.: US 2025/0106721 A1
(43) Pub. Date: Mar. 27, 2025

(54) SERVICE HANDOVER METHOD AND APPARATUS, ELECTRONIC DEVICE, AND STORAGE MEDIUM

(71) Applicant: Luxshare Precision Industry Company Limited, SHENZHEN (CN)

(72) Inventor: GUANHSIUNG WANG, SHENZHEN (CN)

(73) Assignee: Luxshare Precision Industry Company Limited, SHENZHEN (CN)

(21) Appl. No.: 18/783,077

(22) Filed: Jul. 24, 2024

(30) Foreign Application Priority Data
Sep. 21, 2023 (CN) 202311226229.2

(51) Int. Cl. H04W 36/22; H04W 36/30

(52) U.S. Cl. CPC H04W 36/22; H04W 36/30

(57) ABSTRACT

Provided are a service handover method and apparatus, an electronic device, and a storage medium. The method is applied to a first node and includes: transmitting a link request to at least one second node, and receiving response information determined by each second node according to the link request, where the response information at least includes resource load information; determining a radio link channel state indication corresponding to each second node according to the respective resource load information, and selecting a service scheduling node from the at least one second node according to the radio link channel state indication of each second node; transmitting selection information of the service scheduling node and the radio link channel state indication to each second node; and waiting to perform a service handover with a target node, where the target node is a second node that satisfies a preset service handover condition.

### CROSS-REFERENCE TO RELATED APPLICATION(S)

This application claims priority to the Chinese Patent Application No. 202311226229.2 filed on Sep. 21, 2023, the disclosure of which is incorporated herein by reference in its entirety.

### TECHNICAL FIELD

The present disclosure relates to the field of communications and, in particular, to a service handover method and apparatus, an electronic device, and a storage medium.

### BACKGROUND

With the advent of the 5th Generation Mobile Communication Technology (5G) era of mobile communications, in order to satisfy the requirements of a variety of different mobile services and user experiences, a 5G network will utilize the spectrum resources of higher frequency bands, resulting in a reduction in the signal coverage of a 5G base station. Therefore, base stations need to be constructed in a higher density to maintain the original signal coverage quality and services.

In a heterogeneous network in which multiple access technologies coexist in the related art, a user equipment (UE) needs to frequently perform a service handover with 5G base stations to achieve the traffic link. However, the wide use of the 5G base stations undoubtedly greatly increases operation costs such as energy consumption, and the functional replacement of other service providing nodes such as small cell base stations, unmanned aerial vehicles (UAVs), and UEs with cooperation (UEc) is not taken into account. Therefore, there are problems such as low service handover efficiency and poor serving node selection, and the overall energy consumption of the network is high.

### SUMMARY

The present disclosure provides a service handover method and apparatus, an electronic device, and a storage medium.

According to one aspect of the present disclosure, a service handover method is provided. The method is applied to a first node and includes the following steps.

A link request is transmitted to at least one second node, and response information determined by each of the at least one second node according to the link request is received, where the response information at least includes resource load information.

A radio link channel state indication corresponding to each of the at least one second node is determined according to respective resource load information, and a service scheduling node is selected from the at least one second node according to the radio link channel state indication of each of the at least one second node.

Selection information of the service scheduling node and the radio link channel state indication are transmitted to each second node.

A service handover with a target node is waited to be performed, where the target node is a second node of the at least one second node that satisfies a preset service handover condition.

According to another aspect of the present disclosure, a service handover apparatus is provided. The apparatus is applied to a first node and includes a link request and response reception module, a radio link channel state indication and service handover node determination module, a first information transmission module, and a service handover waiting module.

The link request and response reception module is configured to transmit a link request to at least one second node and receive response information determined by each of the at least one second node according to the link request, where the response information at least includes resource load information.

The radio link channel state indication and service handover node determination module is configured to determine a radio link channel state indication corresponding to each of the at least one second node according to the respective resource load information and select a service scheduling node from the at least one second node according to the radio link channel state indication of each of the at least one second node.

The first information transmission module is configured to transmit selection information of the service scheduling node and the radio link channel state indication to each second node.

The service handover waiting module is configured to wait to perform a service handover with a target node, where the target node is a second node of the at least one second node that satisfies a preset service handover condition.

According to another aspect of the present disclosure, a service handover method is provided. The method is applied to a second node of at least one second node and includes the following steps.

A link request transmitted by a first node is received, and corresponding response information is fed back to the first node according to the link request, where the response information at least includes resource load information.

Selection information of a service scheduling node transmitted by the first node is received, and a radio link channel state indication corresponding to the second node is determined according to the resource load information.

A resource balance is determined according to the radio link channel state indication.

The resource balance is transmitted to the service scheduling node among the at least one second node to enable the service scheduling node to determine a target node for performing a service handover with the first node.

According to another aspect of the present disclosure, a service handover apparatus is provided. The apparatus is applied to a second node and includes a link request reception and response feedback module, a first information reception module, a resource balance determination module, and a resource balance transmission module.

The link request reception and response feedback module is configured to receive a link request transmitted by a first node and feed back corresponding response information to the first node according to the link request, where the response information at least includes resource load information.

The first information reception module is configured to receive selection information of a service scheduling node transmitted by the first node and determine a radio link channel state indication corresponding to the second node according to the resource load information.

The resource balance determination module is configured to determine a resource balance according to the radio link channel state indication.

The resource balance transmission module is configured to transmit the resource balance to the service scheduling node among the at least one second node to enable the service scheduling node to determine a target node for performing a service handover with the first node.

According to another aspect of the present disclosure, a service handover method is provided. The method is applied to a service scheduling node among at least one second node and includes the following steps.

A radio link channel state indication corresponding to each of the at least one second node transmitted by a first node and a resource balance transmitted by each of the at least one second node are received.

A target node for performing a service handover with the first node is selected from the at least one second node according to the radio link channel state indication and the resource balance.

According to another aspect of the present disclosure, a service handover apparatus is provided. The apparatus is applied to a service scheduling node among at least one second node and includes a radio link channel state indication and resource balance reception module and a target node selection module.

The radio link channel state indication and resource balance reception module is configured to receive a radio link channel state indication corresponding to each of the at least one second node transmitted by a first node and a resource balance transmitted by each of the at least one second node.

The target node selection module is configured to select a target node for performing a service handover with the first node from the at least one second node according to the radio link channel state indication and the resource balance.

According to another aspect of the present disclosure, an electronic device is provided.

The electronic device includes at least one processor and a memory.

The memory is communicatively connected to the at least one processor.

The memory is configured to store a computer program executable by the at least one processor, and the computer program, when executed by the at least one processor, enables the at least one processor to perform the service handover method in any of the embodiments of the present disclosure.

According to another aspect of the present disclosure, a computer-readable storage medium is provided. The computer-readable storage medium is configured to store computer instructions, where the computer instructions are used for, when executed by a processor, implementing the service handover method in any of the embodiments of the present disclosure.

### BRIEF DESCRIPTION OF DRAWINGS

To illustrate solutions in embodiments of the present disclosure more clearly, the drawings used in the description of the embodiments will be briefly described below. Apparently, the drawings described below illustrate some of embodiments of the present disclosure, and those of ordinary skill in the art may obtain other drawings based on the drawings described below on the premise that no creative work is done.

FIG. 1 is a flowchart of a service handover method according to an embodiment of the present disclosure;

FIG. 2 is a flowchart of a service handover method according to an embodiment of the present disclosure;

FIG. 3 is a flowchart of another service handover method according to an embodiment of the present disclosure;

FIG. 4 is a flowchart of a service handover method according to an embodiment of the present disclosure;

FIG. 5 is a flowchart of a service handover method according to an embodiment of the present disclosure;

FIG. 6 is a flowchart of another service handover method according to an embodiment of the present disclosure;

FIG. 7 is a flowchart of a service handover method according to an embodiment of the present disclosure;

FIG. 8 is a flowchart of a service handover method according to an embodiment of the present disclosure;

FIG. 9 is a flowchart of another service handover method according to an embodiment of the present disclosure;

FIG. 10 is a schematic diagram of a service handover system according to an embodiment of the present disclosure;

FIG. 11 is a schematic diagram of a heterogeneous network architecture according to an embodiment of the present disclosure;

FIG. 12 is a timing diagram of a service handover method according to an embodiment of the present disclosure;

FIG. 13 is a structure diagram of a service handover apparatus according to an embodiment of the present disclosure;

FIG. 14 is a structure diagram of another service handover apparatus according to an embodiment of the present disclosure;

FIG. 15 is a structure diagram of still another service handover apparatus according to an embodiment of the present disclosure; and

FIG. 16 is a structure diagram of an electronic device for implementing the service handover method of the embodiments of the present disclosure.

### DETAILED DESCRIPTION

The solutions in embodiments of the present disclosure will be described clearly and completely in conjunction with the drawings in the embodiments of the present disclosure from which the solutions will be apparent to those skilled in the art. Apparently, the embodiments described herein are part, not all, of embodiments of the present disclosure. Based on the embodiments of the present disclosure, all other embodiments obtained by those of ordinary skill in the art on the premise that no creative work is done are within the scope of the present disclosure.

It is to be noted that the terms “first”, “second” and the like in the specification, claims and drawings of the present disclosure are used to distinguish between similar objects and are not necessarily used to describe a particular order or sequence. It is to be understood that the data so used is interchangeable under appropriate circumstances such that the embodiments of the present disclosure described herein may also be implemented in a sequence not illustrated or described herein. In addition, the term “include”, “have” or any other variant thereof is intended to encompass a non-exclusive inclusion. For example, a process, method, system, product or device that includes a series of steps or units not only includes the expressly listed steps or units but also includes other steps or units that are not expressly listed or are inherent to such a process, method, system, product or device.

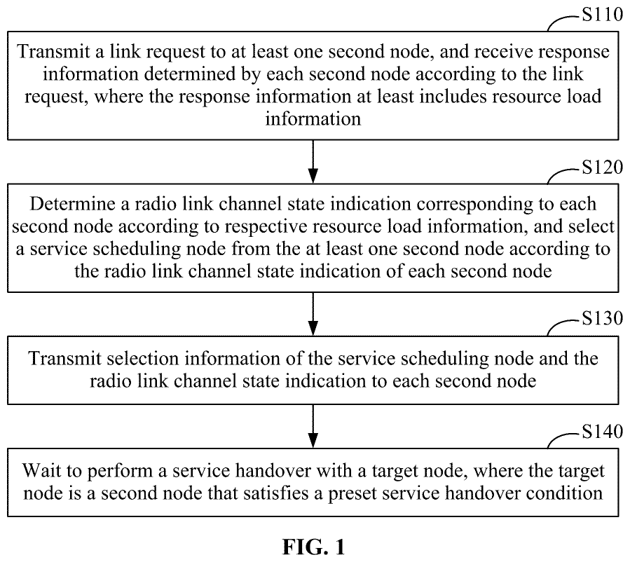

FIG. 1 is a flowchart of a service handover method according to an embodiment of the present disclosure. This embodiment is suitable for the case of performing a service handover on a first node. The method may be performed by a service handover apparatus, and the service handover apparatus may be implemented in hardware and/or software. As shown in FIG. 1, this embodiment provides a service handover method. The method is applied to a first node and specifically includes steps S110 to S140.

In S110, a link request is transmitted to at least one second node, and response information determined by each second node according to the link request is received, where the response information at least includes resource load information.

The first node herein may be understood as a node having a heterogeneous network service requirement. The first node may be a UE, and the UE may include, but is not limited to, a smartphone, a smart wearable device, a tablet computer, a notebook computer, and the like. The second node may be understood as a node that may provide a heterogeneous network service for the first node within the signal coverage of the first node. The second node may include at least one of: a base station (BS), a small cell base station (Small Cell), a Unmanned Aerial Vehicle (UAV) onboard communication station or a UE with cooperation (UEc) that supports cooperative communication (that is, point-to-point communication), where the BS may be a macro base station (MBS) or another type of base station, to which the embodiments of the present disclosure are not limited.

Further, in recent years, the UAV equipped with a 5G/B5G communication module has become a highly flexible and highly mobile airborne base station due to its advantages of high mobility and lightweight appearance and its capability to adapt to different terrains, population distribution and other factors. Meanwhile, the height at which the UAV can operate can reach tens of meters and even several hundred meters, and thus, the communication path attenuation between the UAV and a UE is relatively small. Therefore, the UAV onboard communication station may serve as a service providing node to provide the heterogeneous network service for the first node.

The link request herein may refer to a request message (Req) for requesting the traffic link from the second node. The response information may refer to a response information packet that is fed back by the second node according to the link request received from the first node. The response information may at least include information such as resource load information. The resource load information may be understood as load information including a traffic service such as a telephone service, a voice packet service, a data information transfer service, an access telecommunications network, and an international telephone service, provided by the second node for the first node within the signal coverage of the second node.

In this embodiment of the present disclosure, when the first node in a heterogeneous network needs a heterogeneous network service, the first node may transmit a link request to all the second nodes within the signal coverage of the first node and then wait to receive response information fed back by each second node, where the first node may include a UE such as a smartphone, a smart wearable device, a tablet computer, and a notebook computer, the second node may include, but is not limited to, a BS, a Small Cell, a UAV onboard communication station, a UEc, and the like, and the response information may at least include information such as resource load information.

It is to be understood that the heterogeneous network may refer to a network system consisting of different operating systems and/or computers executing different protocols. For example, the protocol to which the heterogeneous network in this embodiment of the present disclosure is connected may be the 3rd Generation Partnership Project (3GPP) protocol of 5G New Radio (5G NR) or the Point-to-Point Protocol (PPP) protocol of the UEc.

In S120, a radio link channel state indication corresponding to each second node is determined according to the respective resource load information, and a service scheduling node is selected from the at least one second node according to the radio link channel state indication of each second node.

The radio link channel state indication may be understood as an indicator for measuring the signal quality and the channel quality of the communication link between the first node and the second node and may at least include a signal-to-interference-plus-noise ratio (SINR), a channel quality indicator (CQI), and a received signal strength indication (RSSI). The service scheduling node may be understood as a node serving functions of service scheduling and decision-making control in a heterogeneous network and may also be referred to as a coordinator device. The service scheduling node may be one of the second nodes and may be used for selecting a target node that satisfies a condition from multiple second nodes to perform a service handover with the first node.

In this embodiment of the present disclosure, after the first node receives the resource load information fed back by each second node, it indicates that the communication link (that is, a radio channel) between the first node and each second node is connected to each other. Each radio link channel state indication of the communication link may be estimated. The radio link channel state indication may at least include an SINR, a CQI, and an RSSI. The radio link channel state indication may be determined by using an algorithm and/or a formula in the related art, and the embodiments of the present disclosure are not limited thereto. For example, the ratio of the strength of a desired signal received by the first node to the strength of a received interference signal (noise and interference) may be taken as the SINR of the corresponding communication link; the CQI may be estimated based on information such as a measurement reference signal, a cell-specific reference signal or an SINR received by the first node; and the average of the powers of all signals (including pilot signals, data signals, neighbor interference signals, and noise signals) received by the first node may be taken as the RSSI of the corresponding communication link. Then, one service scheduling node may be selected from the second nodes according to the estimated radio link channel state indications. For example, a corresponding node with the highest SINR among the second nodes may be taken as the service scheduling node or a corresponding node with the highest RSSI among the second nodes may be taken as the service scheduling node, and the embodiments of the present disclosure are not limited thereto.

In S130, selection information of the service scheduling node and the radio link channel state indication are transmitted to each second node.

In this embodiment of the present disclosure, after the service scheduling node is selected, the selection information of the service scheduling node and the determined respective radio link channel state indication may be fed back to the corresponding second node.

In S140, a service handover with a target node is waited to be performed, where the target node is a second node that satisfies a preset service handover condition.

The target node may be understood as a node that performs a service handover (that is, the traffic link) with the first node, and the target node may be a certain second node that satisfies the preset service handover condition. The preset service handover condition may refer to a pre-configured judgment condition for determining the target node. The preset service handover condition may include, but is not limited to, the following conditions: whether the SINR corresponding to a second node is greater than a preset SINR threshold, whether the RSSI corresponding to a second node is greater than a preset RSSI threshold, whether the resource balance corresponding to a second node is sufficient to serve the first node, and whether the SINR corresponding to a current second node is greater than the SINR corresponding to another second node.

In this embodiment of the present disclosure, after the first node transmits the selection information of the service scheduling node and the radio link channel state indication to each second node, the first node may wait to perform a service handover with the target node among the second nodes to achieve the traffic link, where the preset service handover condition may include, but is not limited to, the following conditions: whether the SINR corresponding to a second node is greater than a preset SINR threshold, whether the RSSI corresponding to a second node is greater than a preset RSSI threshold, whether the resource balance corresponding to a second node is sufficient to serve the first node, and whether the SINR corresponding to the current second node is greater than the SINR corresponding to another second node.

The solution of one or more embodiments of the present disclosure is applied to a first node and includes the following steps: a link request is transmitted to at least one second node, and response information determined by each second node according to the link request is received, where the response information at least includes resource load information; a radio link channel state indication corresponding to each second node is determined according to the respective resource load information, and a service scheduling node is selected from the at least one second node according to the radio link channel state indication of each second node; the selection information of the service scheduling node and the radio link channel state indication are transmitted to each second node; and a service handover with a target node is waited to be performed, where the target node is a second node that satisfies a preset service handover condition. In one or more embodiment of the present disclosure, the response information of each second node to the link request of the first node is received, the radio link channel state indication corresponding to each second node and the service scheduling node are determined according to the resource load information in each response information, and then the target node that satisfies the preset service handover condition waits to perform a service handover with the first node to achieve the traffic link, thereby improving the quality of service for the first node and the service handover efficiency and reducing the overall energy consumption of a network.

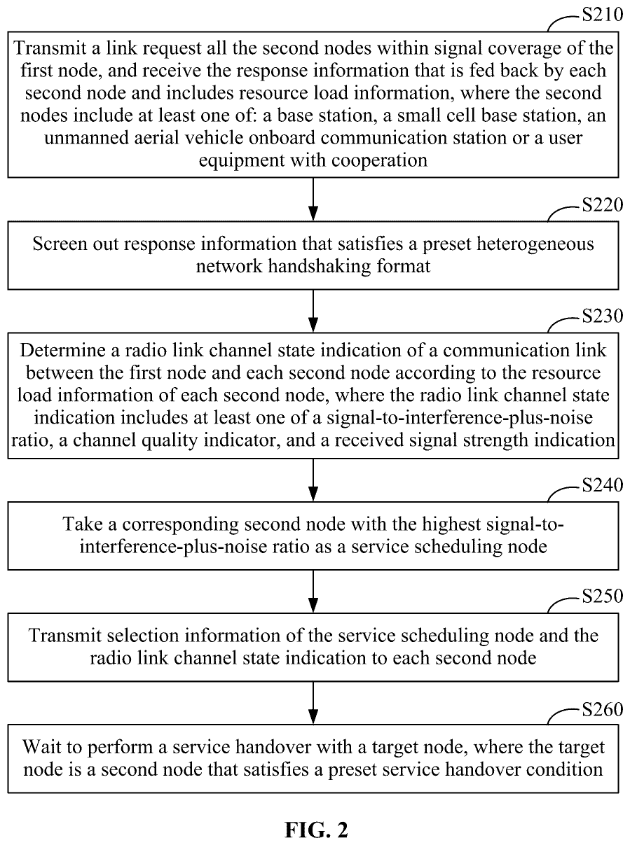

FIG. 2 is a flowchart of a service handover method according to an embodiment of the present disclosure. This embodiment is an optimization and expansion of the preceding embodiments and can be combined with optional solutions in the preceding embodiments. As shown in FIG. 2, this embodiment provides a service handover method. The method is applied to a first node and illustratively includes steps S210 to S260.

In S210, a link request is transmitted to all the second nodes within signal coverage of the first node, and the response information that is fed back by each second node and includes resource load information is received, where the second nodes include at least one of: a base station, a small cell base station, a UAV onboard communication station or a UE with cooperation.

In S220, response information that satisfies a preset heterogeneous network handshaking format is screened out.

The preset heterogeneous network handshaking format may be understood as a preconfigured packet format in which data communication is performed between the first node and the second node in a heterogeneous network. The preset heterogeneous network handshaking format may include information such as a request field, an acknowledgement field, a resource balance, a handover parameter, the type of the second node, and parameter information.

In this embodiment of the present disclosure, when data communication is performed between the first node and the second node in the heterogeneous network, the transmitted data packets need to satisfy the preset heterogeneous network handshaking format. Therefore, after the first node receives the response information fed back by each second node, the first node needs to screen and check whether the packet format of the response information is a packet format approved by a current service handover system and deletes the response information that does not satisfy the preset heterogeneous network handshaking format.

Further, on the basis of the preceding embodiments of the present disclosure, the preset heterogeneous network handshaking (HNHS) format in this embodiment of the present disclosure may at least include the information shown in the following table:

| | | |
|---|---|---|
| HNHS | Header | Data (Payload) |

The parameters of the header may be defined as follows:

| | | |
|---|---|---|
| B7~B6 | 00 | Link Request |
| | 01 | Acknowledge |
| | 10 | Resource Balance |
| | 11 | Handshaking Parameter (SINR, CQI, |
| | | and RSSI) |
| B5~B4 | 00 | Small Cell |
| | 01 | UAV Onboard Communication |
| | | Station |
| | 10 | BS |
| | 11 | UEc |

| | |
|---|---|
| B3~B0 | Parameter Information |

As shown in the above table, the header includes a total of eight bits, where two bits, B7˜B6, can be used for representing four types of message information, that is, Link Request, Acknowledgement, Resource Balance, and Handshaking Parameter (SINR, CQI, and RSSI); two bits, B5˜B4, can be used for representing the type of the second node, that is, Small Cell, BS, UAV Onboard Communication Station, and UEc; and four bits, B3˜B0, can be used for representing specific parameter information. For example, if the HNHS format transmitted by the second node including the header with B7˜B4 as 1011 and Payload, it indicates that the UEc transmits a resource balance back to the first node; if the HNHS format transmitted by the first node including the header with B7˜B4 as 1100 and Payload, it indicates that the first node transmits the handshaking parameter, that is, the radio link channel state indication (an SINR, a CQI, and an RSSI), to a corresponding second node (that is, a small cell) that receives the response information in advance, where the specific content of the handshaking parameter (an SINR, a CQI, and an RSSI) is included in the parameter information represented by B3˜B0.

In S230, a radio link channel state indication of a communication link between the first node and each second node is determined according to the resource load information of each second node, where the radio link channel state indication at least includes an SINR, a CQI, and an RSSI.

In this embodiment of the present disclosure, after the first node receives the resource load information fed back by each second node, each radio link channel state indication of the communication link between the first node and each second node may be estimated, where the radio link channel state indication may at least include an SINR, a CQI, and an RSSI. The radio link channel state indication may be determined by using an algorithm and/or a formula in the related art, and the embodiments of the present disclosure are not limited thereto. For example, the ratio of the strength of a desired signal received by the first node to the strength of a received interference signal (noise and interference) may be taken as the SINR of the corresponding communication link.

In S240, a corresponding second node with the highest SINR is taken as the service scheduling node.

In this embodiment of the present disclosure, a corresponding node with the highest SINR among the second nodes may be taken as the service scheduling node. It is to be understood that taking the corresponding second node with the highest SINR as the service scheduling node is just for the purpose of illustration, and in practical application, the service scheduling node may also be selected by using other channel metrics such as a reference signal receiving power (RSRP), an RSSI, and the like, and the embodiments of the present disclosure are not limited thereto.

In S250, selection information of the service scheduling node and the radio link channel state indication are transmitted to each second node.

In S260, a service handover with a target node is waited to be performed, where the target node is a second node that satisfies a preset service handover condition.

In this embodiment of the present disclosure, after the first node transmits the selection information of the service scheduling node and the radio link channel state indication to each corresponding second node, the first node may wait to perform a service handover with the target node among the second nodes to achieve the traffic link, where the target node may be selected through a preset service handover condition, and the preset service handover condition may at least include the following conditions: the SINR of the radio link channel state indication is greater than a first handover threshold, the RSSI of the radio link channel state indication is greater than a second handover threshold, the sum of a transport block size (TBS) and a buffer capacity of the resource balance is greater than a third handover threshold, and the SINR of the second node is greater than the SINR of another second node.

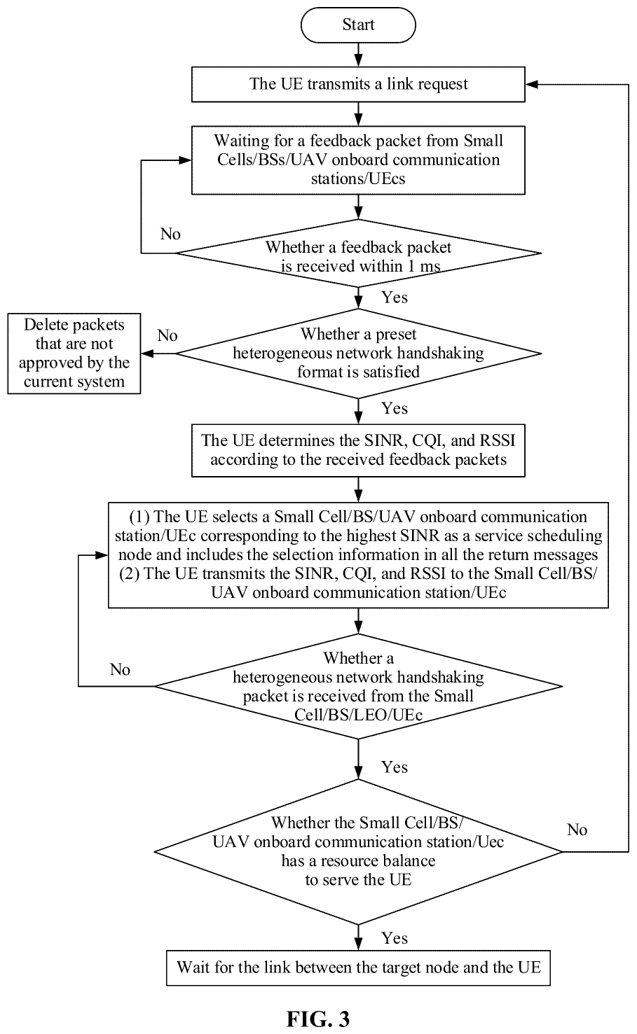

Further, on the basis of the preceding embodiments of the present disclosure, FIG. 3 is a flowchart of another service handover method according to an embodiment of the present disclosure. As shown in FIG. 3, the service handover method is a further refinement of the service handover method shown in FIG. 2. The specific implementation process of the service handover method in FIG. 3 is similar to the process described above, and the details are not repeated herein.

The solution of one or more embodiments of the present disclosure is applied to a first node and includes: a link request is transmitted to all the second nodes within signal coverage of the first node, and the response information that is fed back by each second node and includes resource load information is received, where the second nodes include at least one of: a base station, a small cell base station, a UAV onboard communication station or a UE with cooperation; response information that satisfies a preset heterogeneous network handshaking format is screened out; a radio link channel state indication of a communication link between the first node and each second node is determined according to the resource load information of each second node, where the radio link channel state indication at least includes an SINR, a CQI, and an RSSI; a corresponding second node with the highest SINR is taken as a service scheduling node; the selection information of the service scheduling node and the radio link channel state indication are transmitted to each corresponding second node; and a service handover with a target node is waited to be performed, where the target node is a second node that satisfies a preset service handover condition. In one or more embodiments of the present disclosure, the response information of each second node to the link request of the first node is received, the radio link channel state indication corresponding to each second node and the service scheduling node are determined according to the resource load information in each response information, and then the target node that satisfies the preset service handover condition waits to perform a service handover with the first node to achieve the traffic link, thereby improving the quality of service for the first node and the service handover efficiency and reducing the overall energy consumption of a network.

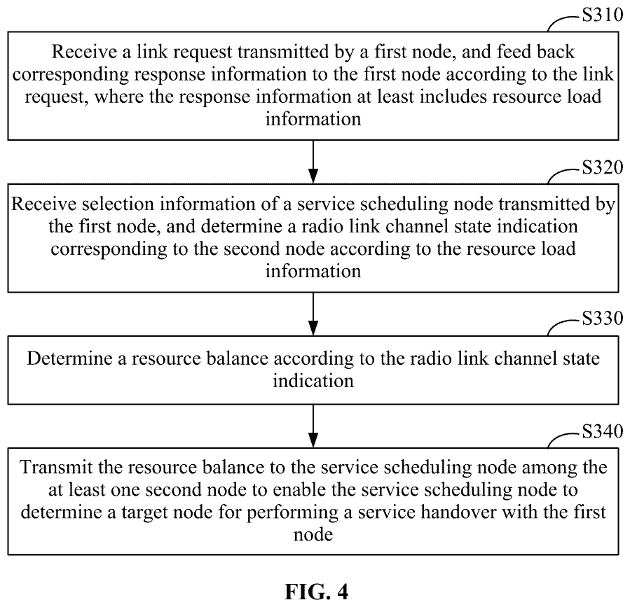

FIG. 4 is a flowchart of a service handover method according to an embodiment of the present disclosure. This embodiment is suitable for the case of performing a service handover for a first node. The method may be performed by a service handover apparatus, and the service handover apparatus may be implemented in hardware and/or software. As shown in FIG. 4, this embodiment provides a service handover method. The method is applied to a second node of the at least one second node and illustratively includes steps S310 to S340.

In S310, a link request transmitted by a first node is received, and corresponding response information is fed back to the first node according to the link request, where the response information at least includes resource load information.

In this embodiment of the present disclosure, when the second node receives the link request transmitted by the first node, whether the packet format of the link request is a packet format approved by a current service handover system is screened and checked, the link request that does not satisfy a preset heterogeneous network handshaking format is rejected, and if the link request satisfies the preset heterogeneous network handshaking format, response information that at least includes resource load information is fed back to the first node.

In S320, selection information of a service scheduling node transmitted by the first node is received, and a radio link channel state indication corresponding to the second node is determined according to the resource load information.

In this embodiment of the present disclosure, the second node may receive the selection information of the service scheduling node and the radio link channel state indication transmitted by the first node so that the second node may subsequently determine its own resource balance according to the information described above.

In S330, a resource balance is determined according to the radio link channel state indication.

The resource balance may be understood as includes the data buffer state information of the second node, and, the resource capacity required by the first node and estimated according to the CQI transmitted by the first node. In an example, the resource balance may include the data transport block size (TBS) required by the first node and the capacity of a buffer or a data storing area of the second node.

In this embodiment of the present disclosure, the second node may estimate the TBS required by the first node according to a pre-configured mapping data table between the radio link channel state indication and the TBS, detect the capacity of the buffer or the data storing area of the second node, and take the TBS required by the first node and the capacity of the buffer or the data storing area of the second node as the resource balance corresponding to the second node.

In S340, the resource balance is transmitted to the service scheduling node among the at least one second node to enable the service scheduling node to determine a target node for performing a service handover with the first node.

In this embodiment of the present disclosure, after each second node determines its own resource balance, each second node may transmit the resource balance to the service scheduling node so that the service scheduling node selects a target node for performing a service handover with the first node from the second nodes according to the radio link channel state indication and the resource balance, thereby achieving the service handover between the first node and the target node.

The solution of one or more embodiments of the present disclosure is applied to a second node and includes: a link request transmitted by a first node is received, and corresponding response information is fed back according to the link request, where the response information at least includes resource load information; selection information of a service scheduling node transmitted by the first node is received, and a radio link channel state indication corresponding to each second node is determined according to the resource load information; a resource balance is determined according to the radio link channel state indication; and the resource balance is transmitted to the service scheduling node among the second nodes to enable the service scheduling node to determine a target node for performing a service handover with the first node. In one or more embodiments of the present disclosure, the corresponding response information is fed back for the link request of the first node, the corresponding resource balance is determined according to the radio link channel state indication fed back by the first node, and the resource balance is transmitted to the service scheduling node among the at least one second node so that the service scheduling node determines the target node for performing the service handover with the first node. The resource balance of each second node can be determined according to the link request of the first node to enable the target node with the best quality of service to perform a service handover with the first node to achieve the traffic link, thereby improving the quality of service for the first node and the service handover efficiency and reducing the overall energy consumption of a network.

FIG. 5 is a flowchart of a service handover method according to an embodiment of the present disclosure. This embodiment is an optimization and expansion of the preceding embodiments and can be combined with optional solutions in the preceding embodiments. As shown in FIG. 5, this embodiment provides a service handover method. The method is applied to a second node of at least one second node and illustratively includes steps S410 to S460.

In S410, a link request transmitted by a first node is received, and corresponding response information is fed back to the first node according to the link request, where the response information at least includes resource load information.

In S420, selection information of a service scheduling node transmitted by the first node is received, and a radio link channel state indication corresponding to the second node is determined according to the resource load information.

In S430, a data transport block size corresponding to the first node is obtained by searching a preset modulation and coding scheme table according to a channel quality indication of the radio link channel state indication.

The preset modulation and coding scheme (MCS) table may refer to a pre-configured rate table with communication rate-influencing factors of interest as the column and MCS indexes as the row, and the TBS corresponding to the first node can be estimated through the preset MCS table.

In this embodiment of the present disclosure, after the radio link channel state indication reported by the first node is received, the preset MCS table may be searched for a corresponding modulation scheme and code rate by using the CQI value of the radio link channel state indication as the index, and the TBS that can be transmitted in the downlink between the first node and the second node may be estimated according to the modulation scheme and the code rate.

It is to be understood that the preset MCS tables used in different enterprises and different communication systems may be different, and for example, the preset MCS table used in this embodiment of the present disclosure may be as follows:

| | | | | |
|---|---|---|---|---|
| CQI | Modulation | Code | | Actual code |
| Index | scheme | rate*1024 | Efficiency | rate |

| | |
|---|---|
| 0 | Out of range |

| | | | | |
|---|---|---|---|---|
| 1 | QPSK | 78 | 0.1523 | 0.076 |
| 2 | QPSK | 120 | 0.2344 | 0.117 |
| 3 | QPSK | 193 | 0.377 | 0.188 |
| 4 | QPSK | 308 | 0.6016 | 0.301 |
| 5 | QPSK | 449 | 0.877 | 0.438 |
| 6 | QPSK | 602 | 1.1758 | 0.588 |
| 7 | 16QAM | 378 | 1.4766 | 0.369 |
| 8 | 16QAM | 490 | 1.9141 | 0.479 |
| 9 | 16QAM | 616 | 2.4063 | 0.602 |
| 10 | 64QAM | 466 | 2.7305 | 0.455 |
| 11 | 64QAM | 567 | 3.3223 | 0.554 |
| 12 | 64QAM | 666 | 3.9023 | 0.65 |
| 13 | 64QAM | 772 | 4.5234 | 0.754 |
| 14 | 64QAM | 873 | 5.1152 | 0.853 |
| 15 | 64QAM | 948 | 5.5547 | 0.926 |

As shown in the preceding table, the more complex the modulation scheme corresponding to the CQI Index is, the better the channel quality is. The larger the CQI value is, the higher the modulation scheme is used, the greater the efficiency is, the larger the corresponding transport block (TBS) is, the higher the downlink peak throughput is provided.

In S440, a buffer capacity of the second node is determined.

In this embodiment of the present disclosure, the second node may check its own buffer capacity and then determine its own resource balance.

In S450, the data transport block size and the buffer capacity are taken as a resource balance.

In this embodiment of the present disclosure, the resource balance may include the TBS required by the first node and the buffer capacity of the second node.

In S460, the resource balance is transmitted to the service scheduling node among the at least one second node to enable the service scheduling node to determine a target node for performing a service handover with the first node.

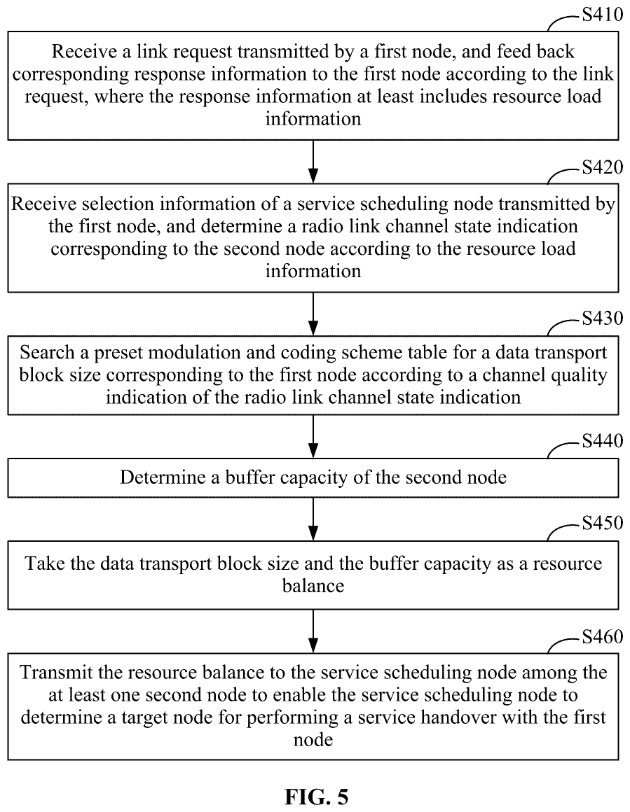

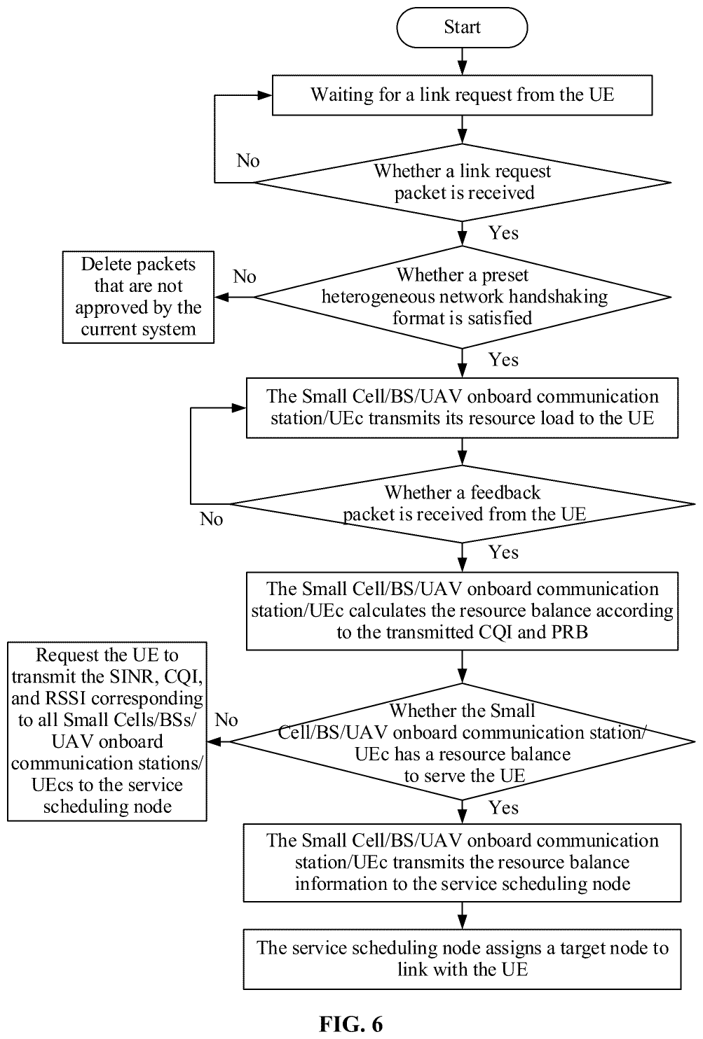

Further, on the basis of the preceding embodiments of the present disclosure, FIG. 6 is a flowchart of another service handover method according to an embodiment of the present disclosure. As shown in FIG. 6, the service handover method is a further refinement of the service handover method shown in FIG. 5. The specific implementation process of the service handover method in FIG. 6 is similar to the process described above, and the details are not repeated herein.

The solution of one or more embodiments of the present disclosure is applied to a second node of at least one second node and includes: a link request transmitted by a first node is received, and corresponding response information is fed back to the first node according to the link request, where the response information at least includes resource load information; the selection information of a service scheduling node transmitted by the first node is received, and a radio link channel state indication corresponding to each second node is determined according to the resource load information; a preset modulation and coding scheme table is searched for a data transport block size corresponding to the first node according to a channel quality indication of the radio link channel state indication; a buffer capacity of the second node is determined; the data transport block size and the buffer capacity are taken as a resource balance; and the resource balance is transmitted to the service scheduling node among the at least one second node to enable the service scheduling node to determine a target node for performing a service handover with the first node. In one or more embodiments of the present disclosure, the corresponding response information is fed back for the link request of the first node, the preset modulation and code scheme table is searched for the corresponding data transport block size according to the radio link channel state indication fed back by the first node, the data transport block size and the buffer capacity of the second node are taken as the resource balance of the second node, and the resource balance is transmitted to the service scheduling node among the at least one second node so that the service scheduling node determines the target node for performing a service handover with the first node. The resource balance of the second node can be determined according to the link request of the first node to enable the target node with the best quality of service to perform a service handover with the first node to achieve the traffic link, thereby improving the quality of service for the first node and the service handover efficiency and reducing the overall energy consumption of a network.

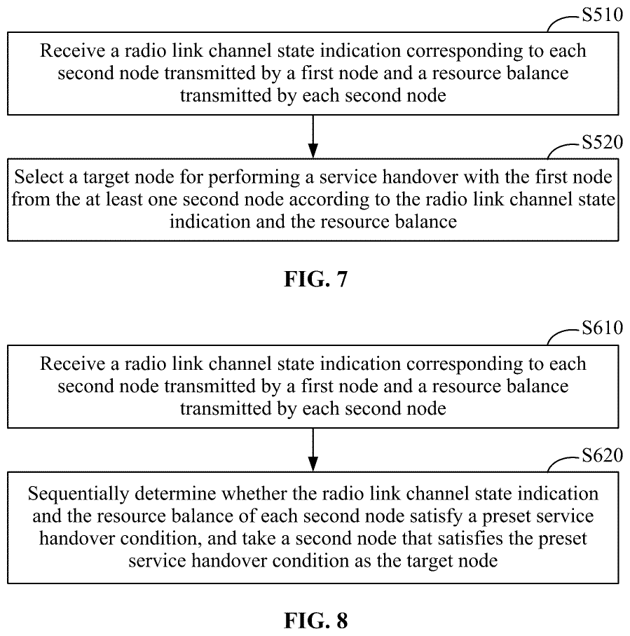

FIG. 7 is a flowchart of a service handover method according to an embodiment of the present disclosure. This embodiment is suitable for the case of performing a service handover on a first node. The method may be performed by a service handover apparatus, and the service handover apparatus may be implemented in hardware and/or software. As shown in FIG. 7, this embodiment provides a service handover method. The method is applied to a service scheduling node among at least one second node and illustratively includes steps S510 to S520.

In S510, a radio link channel state indication corresponding to each second node transmitted by a first node and a resource balance transmitted by each second node are received.

In this embodiment of the present disclosure, the service scheduling node among the second nodes may receive a radio link channel state indication corresponding to each second node transmitted by a first node and a resource balance transmitted by each second node so that the service scheduling node may select a target node for performing a service handover with the first node from the at least one second node according to the radio link channel state indication and the resource balance described above.

In S520, a target node for performing a service handover with the first node is selected from the at least one second node according to the radio link channel state indication and the resource balance.

In this embodiment of the present disclosure, after the service scheduling node receives the radio link channel state indication and the resource balance, the service scheduling node may determine whether each second node satisfies a preset service handover condition and thus select a target node that is used for performing a service handover with the first node from all the at least one second node, where the preset service handover condition may include, but is not limited to, the following conditions: whether the SINR corresponding to a second node is greater than a preset SINR threshold, whether the RSSI corresponding to a second node is greater than a preset RSSI threshold, whether the resource balance corresponding to a second node is sufficient to serve the first node, and whether the SINR corresponding to the current second node is greater than the SINR corresponding to another second node.

The solution of one or more embodiments of the present disclosure is applied to a service scheduling node among the second nodes and includes: a radio link channel state indication corresponding to each second node transmitted by a first node and a resource balance transmitted by each second node are received, and a target node for performing a service handover with the first node is selected from the at least one second node according to the radio link channel state indication and the resource balance. In one or more embodiments of the present disclosure, the target node is selected from the at least one second node according to the radio link channel state indication and the resource balance to enable the target node to perform a service handover with the first node to achieve the traffic link, thereby improving the quality of service for the first node and the service handover efficiency and reducing the overall energy consumption of a network.

FIG. 8 is a flowchart of a service handover method according to an embodiment of the present disclosure. This embodiment is an optimization and expansion of the preceding embodiments and can be combined with optional solutions in the preceding embodiments. As shown in FIG. 8, this embodiment provides a service handover method. The method is applied to a service scheduling node among at least one of second node and illustratively includes steps S610 to S620.

In S610, a radio link channel state indication corresponding to each second node transmitted by a first node and a resource balance transmitted by each second node are received.

In S620, whether the radio link channel state indication and the resource balance of each second node satisfy a preset service handover condition determined, and a second node that satisfies the preset service handover condition is taken as the target node.

In this embodiment of the present disclosure, the service scheduling node may sequentially determine whether each second node satisfies the preset service handover condition according to the radio link channel state indication and the resource balance corresponding to each second node and then selects a target node that satisfies the condition and is used for performing a service handover with the first node, further achieving the traffic link between the first node and the target node.

Further, on the basis of the preceding embodiments of the present disclosure, the service handover method provided by this embodiment of the present disclosure further includes the following steps.

When the radio link channel state indication and the resource balance of a second node do not satisfy the preset service handover condition, whether the corresponding second node with the radio link channel state indication and the resource balance not satisfying the preset service handover condition satisfies a preset overload condition is determined, and if the corresponding second node satisfies the preset overload condition, the corresponding second node is controlled to enter a sleep mode.

In this embodiment of the present disclosure, when the radio link channel status indication and the resource balance of a second node do not satisfy the preset service handover condition, that is, when the second node cannot be used as the target node for performing the service handover, whether the second node satisfies a preset overload condition may be further determined. If it is determined that the second node is overloaded, the second node is controlled to enter a sleep (SLP) mode. Illustratively, if the type of the second node is one of a Small Cell, a BS or a UEc, the second node is controlled to enter the SLP mode; if the type of the second node is a UAV, the second node is controlled to enter a semi-SLP mode to reduce the overall power consumption of the heterogeneous network. The preset overload condition may include at least one of the following conditions: the remaining space of a buffer or a data storing area of the second node is smaller than the size of data to be transmitted by the first node, the remaining usage rate of the central processing unit of the second node is less than a preset central processing unit remaining usage rate threshold or the downlink bandwidth that the second node needs to allocate to the first node is less than a preset downlink bandwidth threshold.

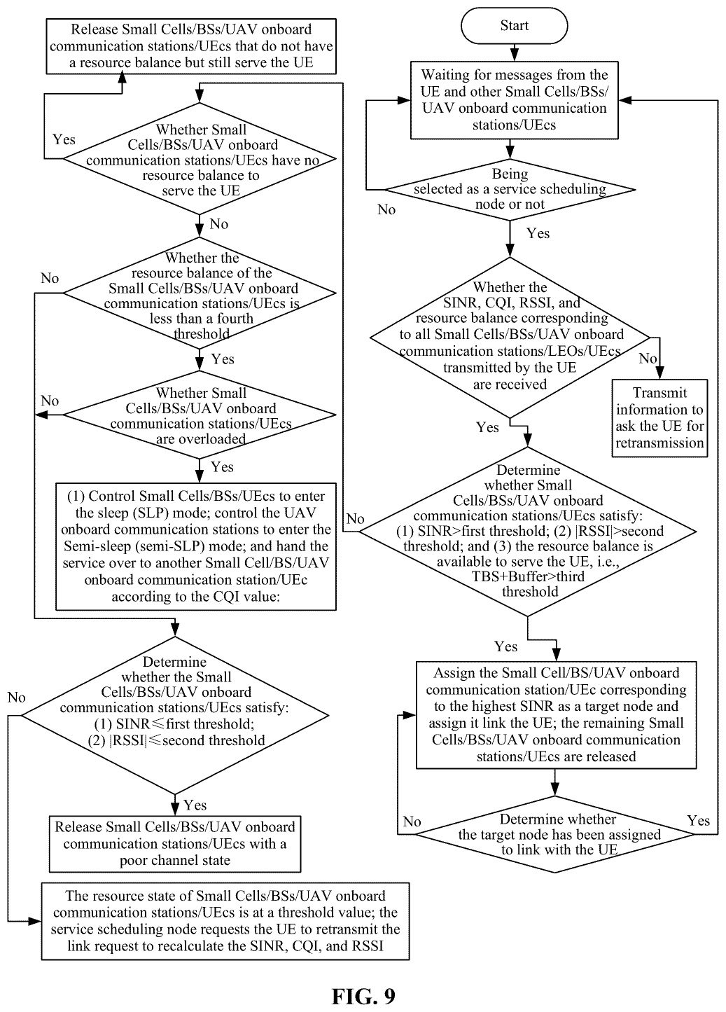

Further, on the basis of the preceding embodiments of the present disclosure, FIG. 9 is a flowchart of another service handover method according to an embodiment of the present disclosure. As shown in FIG. 9, the service handover method is a further refinement of the service handover method shown in FIG. 8, and illustratively, the process for implementing the sleep and release control processes for second nodes other than the target node are added. The process may include the following steps.

Whether a second node other than the target node satisfies the condition that its own resource balance can serve the first node is determined, and if the resource balance of the second node cannot serve the first node, the second node is released.

If the resource balance of the second node can serve the first node, whether the second node satisfies the condition that its own resource balance is less than a fourth threshold and whether the second node is overloaded are further determined, and if the second node does not satisfy the condition, a second node with a poor channel state is released according to the corresponding SINR and RSSI.

If a second node satisfies the condition that its own resource balance is less than the fourth threshold and the second node is in an overloaded state, the second node is controlled to enter a SLP state or a semi-SLP state, and the service is handed over to another second node according to the CQI value corresponding to the at least one second node.

The solution of one or more embodiments of the present disclosure is applied to a service scheduling node among the at least one second node and includes: a radio link channel state indication corresponding to each second node transmitted by a first node and a resource balance transmitted by each second node are received, whether the radio link channel state indication and the resource balance of each second node satisfy a preset service handover condition is sequentially determined, and a second node that satisfies the preset service handover condition is taken as the target node. In one or more embodiments of the present disclosure, the target node that satisfies the preset service handover condition is selected from the at least one second node according to the radio link channel state indication and the resource balance to enable the target node to perform a service handover with the first node to achieve the traffic link, thereby improving the quality of service for the first node and the service handover efficiency and reducing the overall energy consumption of a network.

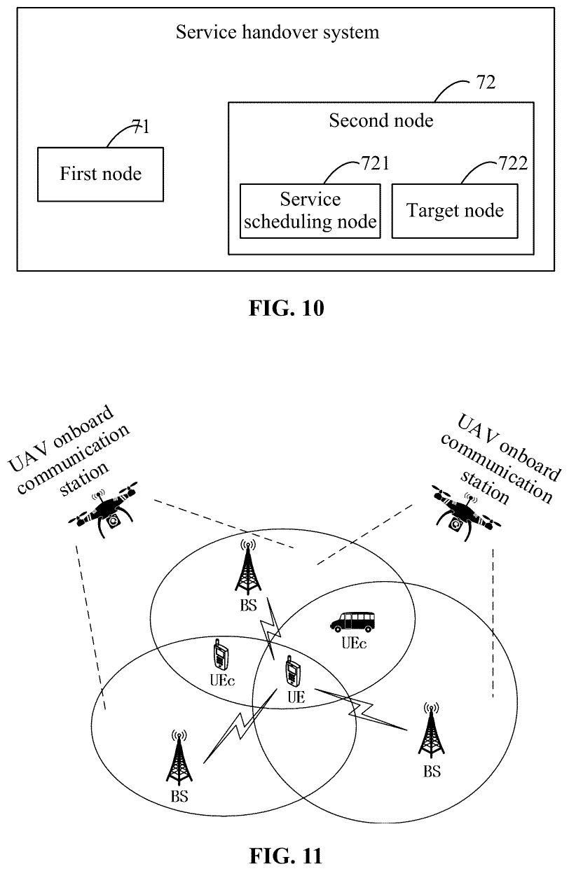

FIG. 10 is a schematic diagram of a service handover system according to an embodiment of the present disclosure. As shown in FIG. 10, the service handover system includes a first node 71 and a second node 72.

The first node 71 is configured to transmit a link request to at least one second node and receive response information determined by each second node according to the link request, where the response information at least includes resource load information; determine a radio link channel state indication corresponding to each second node according to the respective resource load information and select a service scheduling node from the at least one second node according to the radio link channel state indication of each second node; transmit selection information of the service scheduling node and the radio link channel state indication to each second node; and wait to perform a service handover with a target node, where the target node is a second node that satisfies a preset service handover condition.

The second node 72 is configured to receive the link request transmitted by the first node and feed back corresponding response information to the first node according to the link request, where the response information at least includes resource load information; receive the selection information of the service scheduling node transmitted by the first node and determine a radio link channel state indication corresponding to the second node according to the resource load information; determine a resource balance according to the radio link channel state indication; and transmit the resource balance to the service scheduling node among at least one second node to enable the service scheduling node to determine a target node for performing a service handover with the first node.

The second node 72 further includes a service scheduling node 721 and a target node 722.

The service scheduling node 721 is configured to receive a radio link channel state indication corresponding to each second node transmitted by the first node and a resource balance transmitted by each second node and select a target node for performing a service handover with the first node from the at least one second node according to the radio link channel state indication and the resource balance.

The target node 722 is configured to perform a service handover with the first node.

On the basis of the service handover system described above, FIG. 11 is a schematic diagram of a heterogeneous network architecture according to an embodiment of the present disclosure, where the UE is a first node having a heterogeneous network service requirement, and the BSs, the UAV onboard communication stations, and the UEcs are second nodes providing a heterogeneous network service.

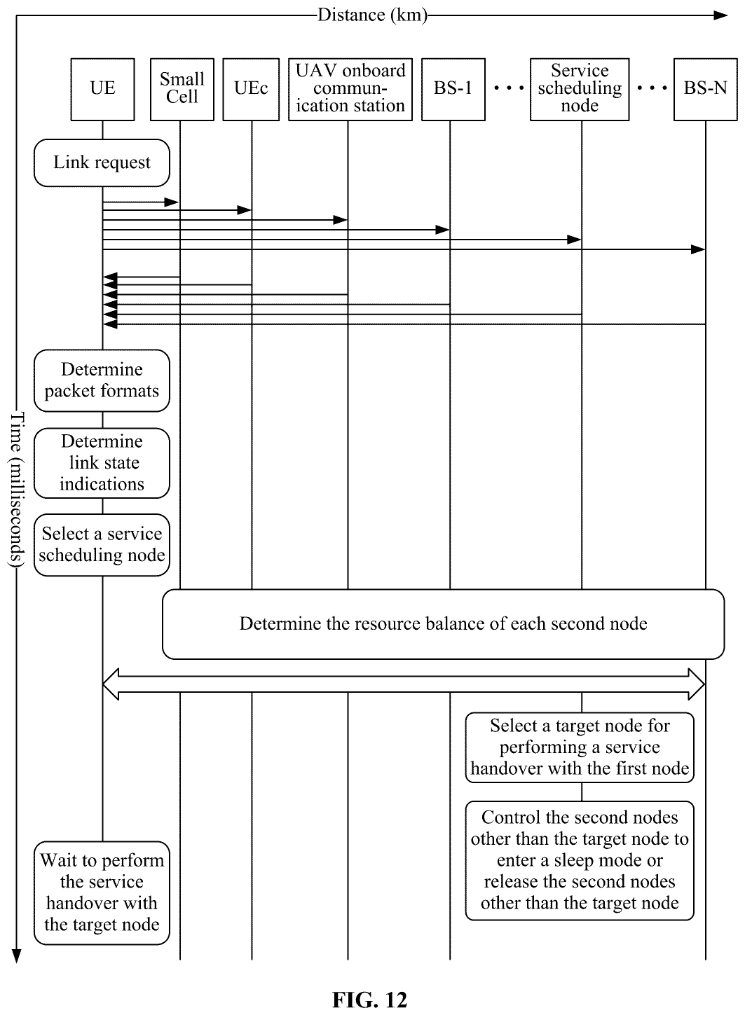

On the basis of the heterogeneous network architecture described above, FIG. 12 is a timing diagram of a service handover method according to an embodiment of the present disclosure. As shown in FIG. 12, the horizontal axis of the timing diagram represents the distance (in kilometers) from the first node to each second node, and the vertical axis represents the time (in milliseconds). For the specific implementation of the service handover method, reference may be made to the preceding embodiments, and the details are not repeated herein.

The service handover system provided by this embodiment of the present disclosure includes a first node and a second node. The service handover system can perform the service handover method provided in any of the embodiments of the present disclosure and has the corresponding functional modules and beneficial effects for performing the method. The service handover system can achieve the service handover between the first node and the target node and can select the most suitable target node from the at least one second node to perform a service handover with the first node, thereby improving the quality of service for the first node and the service handover efficiency and reducing the overall energy consumption of a network.

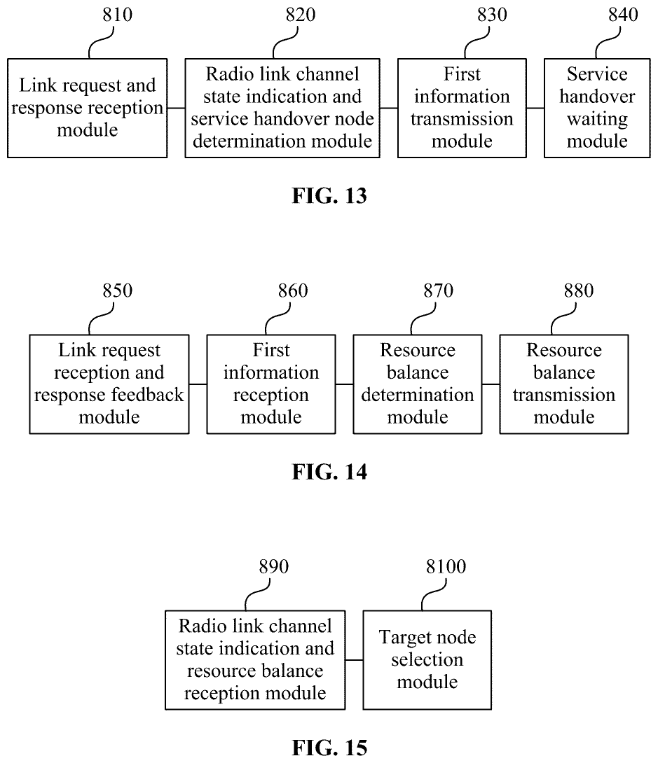

FIG. 13 is a structure diagram of a service handover apparatus according to an embodiment of the present disclosure. As shown in FIG. 13, the service handover apparatus is applied to a first node and includes a link request and response reception module 810, a radio link channel state indication and service handover node determination module 820, a first information transmission module 830, and a service handover waiting module 840.

The link request and response reception module 810 is configured to transmit a link request to at least one second node and receive response information determined by each second node according to the link request, where the response information at least includes resource load information.

The radio link channel state indication and service handover node determination module 820 is configured to determine a radio link channel state indication corresponding to each second node according to the respective resource load information and select a service scheduling node from the at least one second node according to the radio link channel state indication of each second node.

The first information transmission module 830 is configured to transmit selection information of the service scheduling node and the radio link channel state indication to each second node.

The service handover waiting module 840 is configured to wait to perform a service handover with a target node, where the target node is a second node that satisfies a preset service handover condition.

The solution of one or more embodiments of the present disclosure is applied to a first node. In the solution, the link request and response reception module transmits a link request to at least one second node and receives the response information determined by each second node according to the link request, where the response information at least includes resource load information; the radio link channel state indication and service handover node determination module determines a radio link channel state indication corresponding to each second node according to the respective resource load information and selects a service scheduling node from the at least one second node according to the radio link channel state indication of each second node; the first information transmission module transmits the selection information of the service scheduling node and the radio link channel state indication to each second node; and the service handover waiting module waits to perform a service handover with a target node, where the target node is a second node that satisfies the preset service handover condition. In one or more embodiments of the present disclosure, the response information of each second node to the link request of the first node is received, the radio link channel state indication corresponding to each second node and the service scheduling node are determined according to the resource load information in each response information, and then the target node that satisfies the preset service handover condition waits to perform a service handover with the first node to achieve the traffic link, thereby improving the quality of service for the first node and the service handover efficiency and reducing the overall energy consumption of a network.

Further, on the basis of the preceding embodiments of the present disclosure, the link request and response reception module 810 includes a link request and response reception unit and a response information screening unit.

The link request and response reception unit is configured to transmit the link request to all second nodes within signal coverage and receive response information that is fed back by each second node and includes resource load information, where the second nodes include at least one of: a base station, a small cell base station, a UAV onboard communication station or a UE with cooperation.

The response information screening unit is configured to screen out response information that satisfies a preset heterogeneous network handshaking format.

Further, on the basis of the preceding embodiments of the present disclosure, the radio link channel state indication and service handover node determination module 820 includes a radio link channel state indication determination unit and a service scheduling node determination unit.

The radio link channel state indication determination unit is configured to determine a radio link channel state indication of a communication link between the first node and each second node according to the resource load information of each second node, where the radio link channel state indication at least includes an SINR, a CQI, and an RSSI.

The service scheduling node determination unit is configured to take a corresponding second node with the highest SINR as the service scheduling node.

Further, on the basis of the preceding embodiments of the present disclosure, the preset service handover condition at least includes the following conditions: the SINR of the radio link channel state indication is greater than a first handover threshold, the RSSI of the radio link channel state indication is greater than a second handover threshold, the sum of a TBS and a buffer capacity of the resource balance is greater than a third handover threshold, and the SINR of the second node is greater than the SINR of another second node.

FIG. 14 is a structure diagram of another service handover apparatus according to an embodiment of the present disclosure. As shown in FIG. 14, the service handover apparatus is applied to a second node and includes a link request reception and response feedback module 850, a first information reception module 860, a resource balance determination module 870, and a resource balance transmission module 880.

The link request reception and response feedback module 850 is configured to receive a link request transmitted by a first node and feed back corresponding response information to the first node according to the link request, where the response information at least includes resource load information.

The first information reception module 860 is configured to receive selection information of a service scheduling node transmitted by the first node and determine a radio link channel state indication corresponding to the second node according to the resource load information.

The resource balance determination module 870 is configured to determine a resource balance according to the radio link channel state indication.

The resource balance transmission module 880 is configured to transmit the resource balance to the service scheduling node among at least one second node to enable the service scheduling node to determine a target node for performing a service handover with the first node.

The solution of one or more embodiments of the present disclosure is applied to a second node. In the solution, the link request reception and response feedback module receives a link request transmitted by a first node and feeds back corresponding response information to the first node according to the link request, where the response information at least includes resource load information; the first information reception module receives the selection information of a service scheduling node transmitted by the first node and determines a radio link channel state indication corresponding to the second node according to the resource load information; the resource balance determination module determines a resource balance according to the radio link channel state indication; and the resource balance transmission module transmits the resource balance to the service scheduling node among the at least one second node to enable the service scheduling node to determine a target node for performing a service handover with the first node. In one or more embodiments of the present disclosure, the corresponding response information is fed back for the link request of the first node, the corresponding resource balance is determined according to the radio link channel state indication fed back by the first node, and the resource balance is transmitted to the service scheduling node among the at least one second node so that the service scheduling node determines the target node for performing a service handover with the first node. The resource balance of the second node can be determined according to the link request of the first node to enable the target node with the best quality of service to perform a service handover with the first node to achieve the traffic link, thereby improving the quality of service for the first node and the service handover efficiency and reducing the overall energy consumption of a network.

Further, on the basis of the preceding embodiments of the present disclosure, the resource balance determination module 870 includes a data transport block size determination unit, a buffer capacity determination unit, and a resource balance determination unit.

The data transport block size determination unit is configured to search a preset modulation and coding scheme table for a data transport block size corresponding to the first node according to a channel quality indication of the radio link channel state indication.

The buffer capacity determination unit is configured to determine a buffer capacity of the second node.

The resource balance determination unit is configured to take the data transport block size and the buffer capacity as the resource balance.

FIG. 15 is a structure diagram of yet another service handover apparatus according to an embodiment of the present disclosure. As shown in FIG. 15, the service handover apparatus is applied to a service scheduling node among at least one second node and includes a radio link channel state indication and resource balance reception module 890 and a target node selection module 8100.

The radio link channel state indication and resource balance reception module 890 is configured to receive a radio link channel state indication corresponding to each second node transmitted by a first node and a resource balance transmitted by each second node.

The target node selection module 8100 is configured to select a target node for performing a service handover with the first node from the at least one second node according to the radio link channel state indication and the resource balance.

The solution in one or more embodiments of the present disclosure is applied to a service scheduling node among at least one second node. In the solution, the radio link channel state indication and resource balance reception module receives a radio link channel state indication corresponding to each second node transmitted by a first node and a resource balance transmitted by each second node, and the target node selection module selects a target node for performing a service handover with the first node from the at least one second node according to the radio link channel state indication and the resource balance. In one or more embodiments of the present disclosure, the target node is selected from the at least one second node according to the radio link channel state indication and the resource balance to enable the target node to perform a service handover with the first node to achieve the traffic link, thereby improving the quality of service for the first node and the service handover efficiency and reducing the overall energy consumption of a network.

Further, on the basis of the preceding embodiments of the present disclosure, the target node selection module 8100 includes a target node selection unit.

The target node selection unit is configured to sequentially determine whether the radio link channel state indication and the resource balance of each second node satisfy a preset service handover condition and take a second node that satisfies the preset service handover condition as the target node, where the preset service handover condition at least includes the following conditions: the SINR of the radio link channel state indication is greater than a first handover threshold, the RSSI of the radio link channel state indication is greater than a second handover threshold, the sum of a TBS and a buffer capacity of the resource balance is greater than a third handover threshold, and the SINR of the second node is greater than the SINR of another second node.

Further, on the basis of the preceding embodiments of the present disclosure, the service handover apparatus further includes a sleep control module 8110.

The sleep control module 8110 is configured to, when the radio link channel state indication and the resource balance of a second node do not satisfy the preset service handover condition, determine whether the corresponding second node satisfies a preset overload condition, and if the corresponding second node satisfies the preset overload condition, control the second node to enter a sleep mode.

The preset overload condition includes at least one of the following conditions.

The remaining space of a buffer or a data storing area of the second node is smaller than the size of data to be transmitted by the first node.

The remaining usage rate of a central processing unit of the second node is less than a preset central processing unit remaining usage rate threshold.

The downlink bandwidth that the second node needs to allocate to the first node is less than a preset downlink bandwidth threshold.

The service handover apparatus provided by this embodiment of the present disclosure can perform the service handover method provided by any of the embodiments of the present disclosure and has corresponding functional modules and beneficial effects for performing the method.

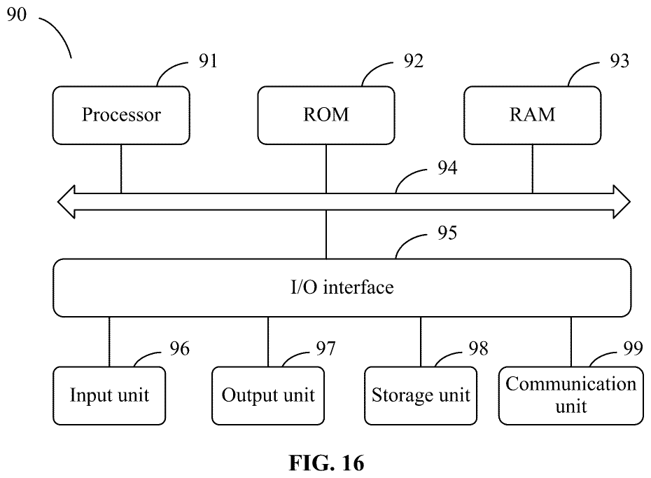

FIG. 16 is a structure diagram of an electronic device 90 for implementing the embodiments of the present disclosure. The electronic device is intended to represent various forms of digital computers, such as laptops, desktops, workstations, personal digital assistants, servers, blade servers, mainframes, and other appropriate computers. The electronic device may also represent various forms of mobile devices, such as personal digital assistants, cellular telephones, smartphones, wearable devices (such as helmets, spectacles, watches, and the like), and other similar computing devices. The components shown here, their connections and relationships, and their functions, are meant to be exemplary only, and are not intended to limit implementations of the present disclosure described and/or claimed in this document.

As shown in FIG. 16, the electronic device 90 may include at least one processor 91 and at least one memory connected to the at least one processor 91, such as a read-only memory (ROM) 92 and a random-access memory (RAM) 93. The memory is configured to store a computer program executable by the at least one processor, and the processor 91 may perform various appropriate actions and processes according to the computer program stored in the ROM 92 or the computer program loaded into the RAM 93 from a storage unit 98. The RAM 93 also stores various programs and data required for the operation of the electronic device 90. The processor 91, the ROM 92, and the RAM 93 are connected to each other via a bus 94. An input/output (I/O) interface 95 is also connected to the bus 94.

Various components connected to the I/O interface 95 in the electronic device 90 include an input unit 96 such as a keyboard, a mouse, and the like; an output unit 97 such as various types of displays, a speaker, and the like; a storage unit 98 such as a magnetic disk, an optical disk, and the like; and a communication unit 99 such as a network card, a modem, a wireless communication transceiver, and the like. The communication unit 99 allows the electronic device 90 to exchange information/data with other devices via, for example, computer networks, such as the Internet, and/or various telecommunication networks.

The processor 91 may be various general-purpose and/or special-purpose processing components having processing and computing capabilities. Some examples of the processor 91 include, but are not limited to, a central processing unit (CPU), a graphic processing unit (GPU), various special-purpose artificial intelligence (AI) computing chips, various processors running machine learning model algorithms, a digital signal processor (DSP), and any appropriate processors, controllers, microcontrollers, and the like. The processor 91 performs various methods and processes described above, such as the service handover method.

In some embodiments, the service handover method may be implemented as a computer program tangibly embodied in a computer-readable storage medium such as the storage unit 98. In some embodiments, part or all of the computer program may be loaded and/or installed on the electronic device 90 via the ROM 92 and/or the communication unit 99. When the computer program is loaded on the RAM 93 and executed by the processor 91, one or more steps of the service handover method described above may be performed. Alternatively, in other embodiments, the processor 91 may be configured to perform the service handover method by any other suitable means (for example, by means of firmware).

Various implementations of the systems and techniques described here can be realized in digital electronic circuitry, integrated circuitry, field-programmable gate arrays (FPGAs), application-specific integrated circuits (ASICs), system-on-a-chip systems (SOCs), complex programmable logic devices (CPLDs), computer hardware, firmware, software, and/or combinations thereof. These various implementations can include implementation in one or more computer programs that are executable and/or interpretable on a programmable system including at least one programmable processor, which may be special or general-purpose and configured to receive data and instructions from, and to transmit data and instructions to, a storage system, at least one input apparatus, and at least one output apparatus.

The computer program for performing the method of the present disclosure may be written in any combination of one or more programming languages. These computer programs may be provided to a processor of a general-purpose computer, a special-purpose computer, or other programmable data processing apparatuses, such that the computer programs, when executed by the processor, cause the functions/operations specified in the flowcharts and/or block diagrams to be implemented. The computer programs may execute entirely on one machine, partly on the machine, as a stand-alone software package, partly on the machine and partly on a remote machine or entirely on the remote computer or server.

In the context of the present disclosure, a computer-readable storage medium may be any tangible medium that can contain, or store a computer program for use by or in connection with an instruction execution system, apparatus, or device. The computer-readable storage medium may be, but not limited to, an electronic, magnetic, optical, electromagnetic, infrared, or semiconductor system, apparatus, or device, or any suitable combination thereof. Alternatively, the computer-readable storage medium may be a machine-readable signal medium. Specific examples of the machine-readable signal medium include an electrical connection based on one or more wires, a portable computer disk, a hard disk, a RAM, a ROM, an erasable programmable read-only memory (EPROM) or a flash memory, an optical fiber, a portable compact disk read- only memory (CD-ROM), an optical memory device, a magnetic memory device, or any suitable combination thereof.

To provide for interaction with a user, the systems and techniques described here can be implemented on an electronic device having a display apparatus (for example, a cathode ray tube (CRT) or liquid crystal display (LCD) monitor) for displaying information to the user and a keyboard and a pointing apparatus (for example, a mouse or a trackball) by which the user can provide input to the electronic device. Other kinds of apparatuses can be used to provide for interaction with a user as well; for example, feedback provided to the user can be any form of sensory feedback (for example, visual feedback, auditory feedback, or tactile feedback); and input from the user can be received in any form, including acoustic, speech, or tactile input.

The systems and techniques described here can be implemented in a computing system that includes a back end component (for example, as a data server), or that includes a middleware component (for example, an application server), or that includes a front end component (for example, a client computer having a graphical user interface or a Web browser through which a user can interact with an implementation of the systems and techniques described here), or that includes any combination of such back end, middleware, or front end components. The components of the system can be interconnected by any form or medium of digital data communication (for example, a communication network). Examples of the communication network include a local area network (LAN), a wide area network (WAN), a blockchain network, and the Internet.

The computer system may include a client and a server. The client and the server are generally remote from each other and typically interact through a communication network. The relationship between the client and the server arises by virtue of computer programs running on the respective computers and having a client-server relationship with each other. The server may be a cloud server, also referred to as a cloud computing server or a cloud host. As a host product in a cloud computing service system, the server solves the defects of difficult management and poor service scalability in the service of a conventional physical host and a related VPS.

It is to be understood that various forms of processes shown above may be adopted with steps reordered, added or deleted. For example, the steps described in the present disclosure may be performed in parallel, sequentially or in different orders, as long as the desired results of the technical solutions of the present disclosure can be achieved, and no limitation is imposed herein.

The preceding embodiments do not limit the scope of the present disclosure. It is to be understood by those skilled in the art that various modifications, combinations, sub-combinations, and substitutions may be performed according to design requirements and other factors. Any modifications, equivalent substitutions, improvements and the like made within the spirit and principle of the present disclosure are within the scope of the present disclosure.

What is claimed is:

1. A service handover method, applied to a first node and comprising:
transmitting a link request to at least one second node, and receiving response information determined by each of the at least one second node according to the link request, wherein the response information at least comprises resource load information;
determining a radio link channel state indication corresponding to each of the at least one second node according to respective resource load information, and selecting a service scheduling node from the at least one second node according to the radio link channel state indication of each of the at least one second node;
transmitting selection information of the service scheduling node and the radio link channel state indication to each of the at least one second node; and
waiting to perform a service handover with a target node, wherein the target node is a second node of the at least one second node that satisfies a preset service handover condition.

2. The method according to claim 1, wherein the transmitting a link request to at least one second node and receiving response information determined by each of the at least one second node according to the link request comprises:
transmitting the link request to all the at least one second node within signal coverage of the first node, and receiving the response information that is fed back by each of the at least one second node, wherein the response information comprises the resource load information, wherein the at least one second node comprise at least one of: a base station, a small cell base station, an unmanned aerial vehicle onboard communication station or a user equipment with cooperation; and
screening out the response information that satisfies a preset heterogeneous network handshaking format.

3. The method according to claim 1, wherein the determining a radio link channel state indication corresponding to each of the at least one second node according to the respective resource load information and selecting a service scheduling node from the at least one second node according to the radio link channel state indication of each of the at least one second node comprises:
determining the radio link channel state indication of a communication link between the first node and each of the at least one second node according to the resource load information of each of the at least one second node, wherein the radio link channel state indication at least comprises a signal-to-interference-plus-noise ratio, a channel quality indicator, and a received signal strength indication; and
taking a corresponding second node of the at least one second node with a highest signal-to-interference-plus-noise ratio as the service scheduling node.

4. The method according to claim 1, wherein the preset service handover condition at least comprises: a signal-to-interference-plus-noise ratio of the radio link channel state indication being greater than a first handover threshold, a received signal strength indication of the radio link channel state indication being greater than a second handover threshold, a sum of a transport block size and a buffer capacity of a resource balance being greater than a third handover threshold, and a signal-to-interference-plus-noise ratio of the second node being greater than a signal-to-interference-plus-noise ratio of another second node of the at least one second node.

5. A service handover method, applied to a second node of at least one second node, and comprising:
receiving a link request transmitted by a first node, and feeding back corresponding response information to the first node according to the link request, wherein the response information at least comprises resource load information;
receiving selection information of a service scheduling node transmitted by the first node, and determining a radio link channel state indication corresponding to the second node according to the resource load information;
determining a resource balance according to the radio link channel state indication; and
transmitting the resource balance to the service scheduling node among the at least one second node to enable the service scheduling node to determine a target node for performing a service handover with the first node.

6. The method according to claim 5, wherein the determining a resource balance according to the radio link channel state indication comprises:
searching a preset modulation and coding scheme table for a data transport block size corresponding to the first node according to a channel quality indication of the radio link channel state indication;
determining a buffer capacity of the second node; and
taking the data transport block size and the buffer capacity as the resource balance.

7. A service handover method, applied to a service scheduling node among at least one second node and comprising:
receiving a radio link channel state indication corresponding to each of the at least one second node transmitted by a first node and a resource balance transmitted by each of the at least one second node; and
selecting a target node for performing a service handover with the first node from the at least one second node according to the radio link channel state indication and the resource balance.

8. The method according to claim 7, wherein the selecting a target node for performing a service handover with the first node from the at least one second node according to the radio link channel state indication and the resource balance comprises:
determining whether the radio link channel state indication and the resource balance of each of the at least one second node satisfy a preset service handover condition, and taking a second node that satisfies the preset service handover condition as the target node, wherein the preset service handover condition at least comprises: a signal-to-interference-plus-noise ratio of the radio link channel state indication being greater than a first handover threshold, a received signal strength indication of the radio link channel state indication being greater than a second handover threshold, a sum of a transport block size and a buffer capacity of the resource balance being greater than a third handover threshold, and a signal-to-interference-plus-noise ratio of the second node being greater than a signal-to-interference-plus-noise ratio of another second node of the at least one second node.

9. The method according to claim 8, further comprising:
in response to the radio link channel state indication and the resource balance of a second node not satisfying the preset service handover condition, determining whether a corresponding second node with the radio link channel state indication and the resource balance not satisfying the preset service handover condition satisfies a preset overload condition, and if the corresponding second node satisfies the preset overload condition, controlling the corresponding second node to enter a sleep mode;
wherein the preset overload condition comprises at least one of the following:
a remaining space of a buffer or a data storing area of a second node is smaller than a size of data to be transmitted by the first node;
a remaining usage rate of a central processing unit of a second node is less than a preset central processing unit remaining usage rate threshold; or
a downlink bandwidth that the second node needs to allocate to the first node is less than a preset downlink bandwidth threshold.

10. An electronic device, comprising:
at least one processor; and
a memory communicatively connected to the at least one processor;
wherein the memory is configured to store a computer program executable by the at least one processor, and the computer program, when executed by the at least one processor, enables the at least one processor to perform the service handover method according to claim 1.

11. The electronic device according to claim 10, wherein the computer program, when executed by the at least one processor, enables the at least one processor to further perform:
transmitting the link request to all the at least one second node within signal coverage of the first node, and receiving the response information that is fed back by each of the at least one second node, wherein the response information comprises the resource load information, wherein the at least one second node comprise at least one of: a base station, a small cell base station, an unmanned aerial vehicle onboard communication station or a user equipment with cooperation; and
screening out the response information that satisfies a preset heterogeneous network handshaking format.

12. The electronic device according to claim 10, wherein the computer program, when executed by the at least one processor, enables the at least one processor to further perform:
determining the radio link channel state indication of a communication link between the first node and each of the at least one second node according to the resource load information of each of the at least one second node, wherein the radio link channel state indication at least comprises a signal-to-interference-plus-noise ratio, a channel quality indicator, and a received signal strength indication; and
taking a corresponding second node of the at least one second node with a highest signal-to-interference-plus-noise ratio as the service scheduling node.

13. The electronic device according to claim 10, wherein the preset service handover condition at least comprises: a signal-to-interference-plus-noise ratio of the radio link channel state indication being greater than a first handover threshold, a received signal strength indication of the radio link channel state indication being greater than a second handover threshold, a sum of a transport block size and a buffer capacity of a resource balance being greater than a third handover threshold, and a signal-to-interference-plus-noise ratio of the second node being greater than a signal-to-interference-plus-noise ratio of another second node of the at least one second node.

14. An electronic device, comprising:
at least one processor; and
a memory communicatively connected to the at least one processor;
wherein the memory is configured to store a computer program executable by the at least one processor, and the computer program, when executed by the at least one processor, enables the at least one processor to perform the service handover method according to claim 5.

15. The electronic device according to claim 14, wherein the computer program, when executed by the at least one processor, enables the at least one processor to further perform:
searching a preset modulation and coding scheme table for a data transport block size corresponding to the first node according to a channel quality indication of the radio link channel state indication;
determining a buffer capacity of the second node; and
taking the data transport block size and the buffer capacity as the resource balance.

16. An electronic device, comprising:
at least one processor; and
a memory communicatively connected to the at least one processor;
wherein the memory is configured to store a computer program executable by the at least one processor, and the computer program, when executed by the at least one processor, enables the at least one processor to perform the service handover method according to claim 7.

17. The electronic device according to claim 16, wherein the computer program, when executed by the at least one processor, enables the at least one processor to further perform:
determining whether the radio link channel state indication and the resource balance of each of the at least one second node satisfy a preset service handover condition, and taking a second node that satisfies the preset service handover condition as the target node, wherein the preset service handover condition at least comprises: a signal-to-interference-plus-noise ratio of the radio link channel state indication being greater than a first handover threshold, a received signal strength indication of the radio link channel state indication being greater than a second handover threshold, a sum of a transport block size and a buffer capacity of the resource balance being greater than a third handover threshold, and a signal-to-interference-plus-noise ratio of the second node being greater than a signal-to-interference-plus-noise ratio of another second node of the at least one second node.

18. The electronic device according to claim 17, wherein the computer program, when executed by the at least one processor, enables the at least one processor to further perform:
in response to the radio link channel state indication and the resource balance of a second node not satisfying the preset service handover condition, determining whether a corresponding second node with the radio link channel state indication and the resource balance not satisfying the preset service handover condition satisfies a preset overload condition, and if the corresponding second node satisfies the preset overload condition, controlling the corresponding second node to enter a sleep mode;
wherein the preset overload condition comprises at least one of the following:
a remaining space of a buffer or a data storing area of a second node is smaller than a size of data to be transmitted by the first node;
a remaining usage rate of a central processing unit of a second node is less than a preset central processing unit remaining usage rate threshold; or
a downlink bandwidth that the second node needs to allocate to the first node is less than a preset downlink bandwidth threshold.

19. A non-transitory computer-readable storage medium storing computer instructions, wherein the computer instructions are used for, when executed by a processor, implementing the service handover method according to claim 1.

20. A non-transitory computer-readable storage medium storing computer instructions, wherein the computer instructions are used for, when executed by a processor, implementing the service handover method according to claim 5.
